(19) United States
(12) Patent Application Publication
(10) Pub. No.: US 2004/0180136 A1
(43) Pub. Date: Sep. 16, 2004

(54) Application system and application method for protective layer forming material

(75) Inventors: Bansei Nagase, Saitama (JP); Hiromi Okubo, Saitama (JP); Masahito Terabe, Saitama (JP)

Correspondence Address: CARRIER BLACKMAN AND ASSOCIATES, 24101 NOVI ROAD, SUITE 100, NOVI, MI, 48375

(73) Assignee: Honda Motor Co., Ltd., Tokyo (JP)

(21) Appl. No.: 10/745,960

(22) Filed: Dec. 26, 2003

(30) Foreign Application Priority Data
Dec. 27, 2002 (JP) 2002-381880

(51) Int. Cl. B05D 1/00; B05C 1/00; B65B 33/00

(52) U.S. Cl. 427/154; 427/428.1; 118/216

(57) ABSTRACT

Robots 16a, 16b, 16c which are able to be motion trained and controlled by controller 18 are established in close proximity to transport line 12. A roller mechanism 34 with a roller 48 made from a material which absorbs and holds protective layer forming material is established at the tip end of each robot 16a, 16b, 16c. Protective layer forming material uses an acrylic type copolymer material which forms a peelable protective layer when dried. Controller 18 records the training data which trains robots 16a, 16b, 16c to rotate and move so that roller 48 contacts vehicle 14, and vehicle 14 which has finished with painting is introduced; robots 16a, 16b, 16c are made to move according to the training data, protective layer forming material is supplied to roller 48, and protective layer forming material is applied to vehicle 14. To automate the process of applying protective layer forming material, to improve production efficiency, to simplify operations, and to make application quality consistent.

### 1. TECHNICAL FIELD OF THE INVENTION

The present invention relates to an application system and method for applying a protective layer forming material to an exterior surface of an object such as a vehicle, as well as a coating object having the protective layer forming material applied thereto and an object having a peelable protective layer thereon. More particularly, the invention relates to such an application system and method for applying a protective layer forming material to the object surface, which material becomes a peelable protective layer after it dries, as well as a coating object having the protective layer forming material applied thereto and the object having a peelable protective layer thereon.

### 2. DESCRIPTION OF RELEVANT ART

Objects such as automobiles are often stored outdoors in stock yards after manufacturing and are transported by trailer and ship, or the like, before being delivered to the consumer. During this time, there is a possibility that the multiple paint layers on the vehicle exterior surface will be damaged, e.g., the quality of the surface layer will be attacked during the long storage and transportation period by dust, metallic powder, salt, oils, acids, and exposure to direct sunlight, or the like. In order to prevent this condition, methods are known where a peelable protective layer is formed on the painted region prior to vehicle shipment, such as disclosed in Japanese Disclosure Bulletin 2001-89697 (Paragraphs 0022˜0027). In the known method, a peelable protective layer is formed by applying a protective layer forming material, which is a liquid wrap material (also known as strippable paint), and then dried so that the painted region can be protected. Furthermore, the layer can be easily peeled off for removal, and yet will not peel off by itself during normal storage.

The process of applying the protective layer forming material before the peelable protective layer is dry consists of applying protective layer forming material to a roller and having several operators rotating the rollers to apply the protective layer forming material.

In order to automate this operation so that the burden on operators will be reduced and coating quality will be consistent, a method has been proposed wherein after the protective layer forming material on the vehicle has been inspected, the protective layer forming material is spread out by applying blown air, such as disclosed in Japanese Patent Disclosure Bulletin H8-173,882 (Drawing 1). Using this method, many of the operations of the protective layer forming material application process are automated, the operator burden is lightened, and tact time can be improved, which is favorable.

Furthermore, a resin coating known as a scratch cover may be temporarily applied in the factory where the vehicle is manufactured in order to ensure that the vehicle body is not scratched during the assembly process. A scratch cover is, for instance, temporarily applied to the front and side surfaces and then removed prior to shipping. A different shape of scratch cover must be prepared for each vehicle type, and it is also necessary to prepare multiple scratch covers depending on the number vehicles produced each day on the transport line.

Now, in the method disclosed in previously mentioned Japanese Patent Disclosure Bulletin H8-173,882, the distribution of the protective layer forming material is not necessarily consistent, and the protective layer forming material is not applied to the edge of the roof in order to prevent scattering of the protective layer forming material.

Furthermore, automobile bodies have more complex shapes recently, and there are some with concave and convex regions or with complex curved surfaces. Applying protective layer coating material to the concave/convex regions and the complex curved surfaces using an air nozzle is difficult. Additionally, it is necessary to apply the protective layer forming material even thicker in areas where the painting quality is seen to be particularly important, but it is difficult to adjust the thickness of the coating if an air nozzle is used to apply the protective layer forming material.

Therefore, after the protective layer forming material is applied by an air nozzle, action must be taken where several operators use rollers to manually spread out the protective layer forming material to the detailed regions such as the edge of the roof, or the concave/convex regions. This becomes a burden on the operators and variation in the quality of the coating will occur depending on the skill of the operators.

### SUMMARY OF THE INVENTION

In consideration of the limitations and disadvantages of the known methods, an object of the present invention is to provide an application system and application method whereby the process to apply a protective layer forming material on an object can be further automated, production efficiency can be improved, operations can be simplified, and application quality can become consistent.

According to one aspect of the present invention, there is provided a system for applying a protective layer forming material to a surface of an object, comprising: a motion-trainable application equipment located near a vehicle transport line; a liquid protective layer forming material which forms a peelable protective layer when dry; a roller mechanism with a freely rotating roller and operatively associated with the application equipment; a supply mechanism which supplies the protective layer forming material to the roller; and a controller which controls the application equipment. The controller maintains training data for training the application equipment to cause the roller to contact a surface of the object and rotate; and when the object is transported near the application equipment, the controller controls the application equipment to move based on the training data and the protective layer forming material is provided to the roller by the supply mechanism and at the same time the protective layer forming material is applied to an exterior surface of said object.

With such system according to the invention, through the supply of a protective layer forming material to the roller while operating the roller mechanism with the application equipment, the protective layer forming material application process can be automated, production efficiency can be improved, the work can be simplified, and the quality of the application can be made consistent.

In this case, if the application equipment is a robot and the object is a vehicle, it is preferable that the robot be able to move along the complex shape of the vehicle. Furthermore, if an acrylic type copolymer is used as the protective layer forming material, the painted region of the vehicle can be more positively protected, and when the layer is to be removed, it will easily peel off.

Additionally, the supply mechanism may include a supply switchover valve which can be operated to selectively supply the protective layer forming material and water to the roller, and the controller can control the supply switchover valve to supply water to the roller to wash the roller.

Also, the controller may maintain multiple sets or blocks of training data which correspond to different types of objects (or vehicles), and the application equipment is controlled to move based on the set or block of training data corresponding to the type of object.

Furthermore, the roller should be made of a material which absorbs and holds the protective layer forming material.

The present invention also encompasses an object having a protective layer coating material applied thereto by the protective layer application system as defined above. The coating quality of the object is maintained because the protective layer coating material is applied by such the protective layer application system.

The present invention also encompasses an object having a peelable protective layer formed thereon, wherein the peelable protective layer is formed by applying a protective layer coating material to the object by the protective layer application system as defined above, and then drying the applied protective layer coating material. Therefore, the peelable protective layer is applied at a consistent thickness, and both insufficient film thickness and excessive or unnecessary film thickness can be prevented.

Also, if the peelable protective layer is transparent, the color of the object can be confirmed through the protective layer. In this case, the peelable protective layer should be transparent to the degree that the color of the object can be confirmed, and it is also acceptable for the peelable protective layer to be semi-transparent or to be transparent with a small amount of color.

According to the present invention, there is also provided a method for a applying protective layer forming material onto a surface of an object, involving use of a motion-trainable application equipment to apply a liquid protective layer forming material which forms a peelable protective layer after drying and a roller mechanism which is operatively associated with the application equipment and has a freely rotating roller, the method comprising the steps of: training motions of the application equipment in advance based on a shape of an object; supplying said protective layer forming material to the roller; and when the object is brought near, controlling the application equipment to execute the trained motions, and the roller is made to contact a surface of the object and rotate while the protective layer forming material is applied.

With such method according to the invention, by operating a roller mechanism with a roller by an application equipment and supplying protective layer forming material to the roller, the protective layer forming material application process can be automated, production efficiency can be improved, the work can be simplified, and the quality of the application can be made consistent.

In this case, the object may be a component which makes up a prescribed product, and if the product is in an incomplete stage, the protective layer forming material can be easily applied to the object. Furthermore, if the protective layer forming material is applied after a prescribed (e.g., finish) painting is performed on the object, the surface of the object can be protected even during the time from painting until the product is completed.

Moreover, once the protective layer forming material is dried, it may be peeled off prior to using the object as the completed product. For convenience, the dried protective layer forming material may be peeled off by spraying water or an aqueous solution against the edges of the peelable protective layer.

Other objects, advantages and salient features of the present invention will be understood from the following detailed description which, in conjunction with the annexed drawings, discloses present embodiments thereof.

### BRIEF DESCRIPTION OF DRAWINGS

FIG. 1 is a perspective view of a system for applying protective layer forming according to the present invention.

FIG. 2 is a front elevational view of the application system of FIG. 1.

FIG. 3 is a perspective view of a robot and an associated roller mechanism of the application system of FIG. 1.

FIG. 4 is a circuit diagram showing the hydraulic and pneumatic complex circuits used in the application system of FIG. 1.

FIG. 5 is a simplified perspective drawing showing the process of applying protective layer forming material to a vehicle by roller according to the present invention.

FIG. 6 is a schematic diagram showing the positional relationship between the robots and the vehicle surface during a process of training the motion of the robot by offline training.

FIG. 7 is a simplified perspective drawing showing a modified process according to the present invention in which protective layer forming material is supplied from a tray.

### DETAILED DESCRIPTION OF INVENTION

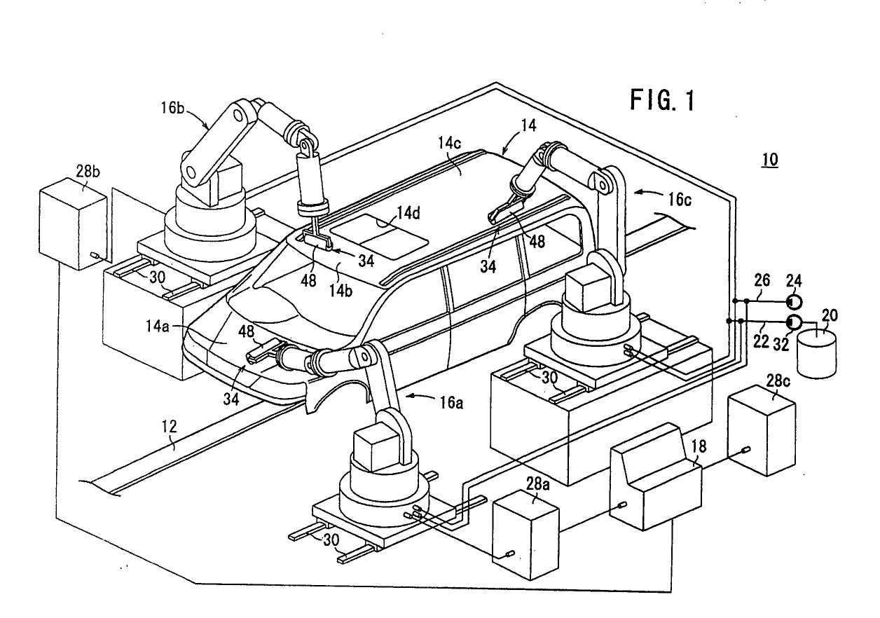

Embodiments of an application system and method for applying a protective layer forming material according to the present invention are presented and described while referring to the attached FIGS. 1-7.

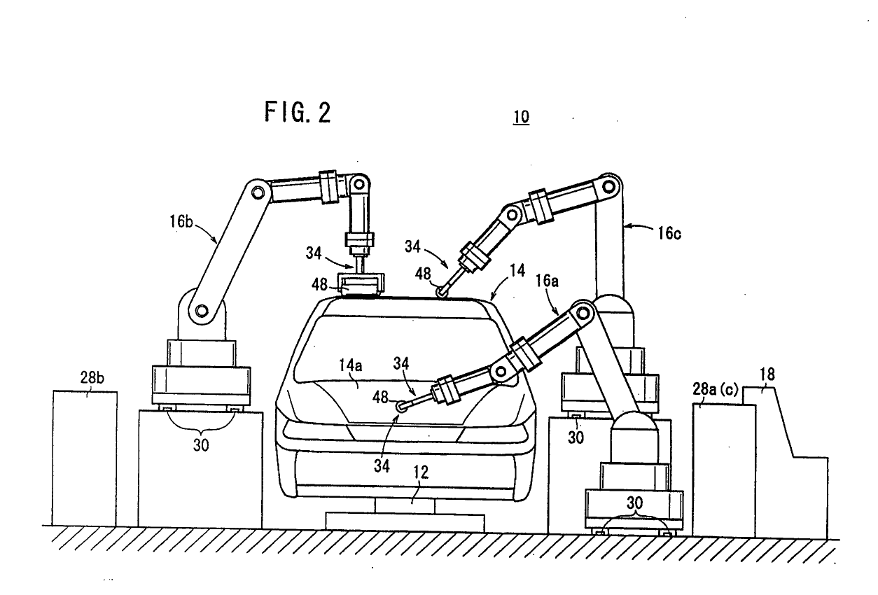

As shown in FIGS. 1 and 2, an application system 10 for the protective layer forming material of an embodiment of the present invention is established on an automobile transport line 12, and applies a protective layer forming material on a body of vehicle (coating object) 14 which has, for example, been completed painted with a finish paint. The application system 10 is comprised of: three industrial robots (application equipment) 16a, 16b, 16c, controller 18 which controls the entire system, tank 20 which stores the protective layer forming material, application material piping 22 which connects from the tank 20 to each robot 16a, 16b, 16c, and water piping 26 which supplies water from a water supply source 24 to the robots 16a, 16b, 16c. Robots 16a, 16b, 16c are each controlled by robot controllers 28a, 28b, 28c, respectively, which are connected to the controller 18.

The robots 16a and 16c are positioned at transport line 12 on the left-hand side in the direction of vehicle 14 progression, and the robot 16b is positioned on the right-hand side in the direction of progression. Furthermore, the robot 16a is positioned toward the front in the direction of progression, the robot 16b is positioned around the middle in the direction of progression, and the robot 16c is positioned toward the back in the direction of progression. The robots 16a, 16b, 16c are able to move along slide rails 30 which extend parallel to transport line 12.

Pump 32 is established along the application material piping 22, and draws up protective layer forming material from the tank 20 and provides it to the robots 16a, 16b, 16c. Furthermore, the tank 20 and application material piping 22 may be temperature-controlled using a heater and a thermometer not shown in the drawings, in order to maintain the protective layer forming material at an appropriate temperature. Roller mechanisms 34 at the tip ends of the robots 16a, 16b, 16c are supplied with the protective layer forming material by the application material piping 22.

The protective layer forming material may, for example, comprise acrylic copolymers as the main ingredient, such as two types of acrylic copolymers with differing glass transition temperatures. Specifically, for instance, the protective layer forming material shown in previously mentioned in Japanese Disclosure Bulletin 2001-89697 may be used. Furthermore, the viscosity of the water based protective layer forming material can be adjusted by changing the ratio of water contained therein and the material temperature. When dried, the protective layer forming material adheres tightly to the vehicle 14, and can chemically and physically protect the painted surface regions of vehicle 14 from dust, metallic dust, salt, oils, acids, and direct sunlight or the like. Furthermore, when the protective layer forming material is to be removed, such as when vehicle 14 is delivered to the user, it can easily be peeled off.

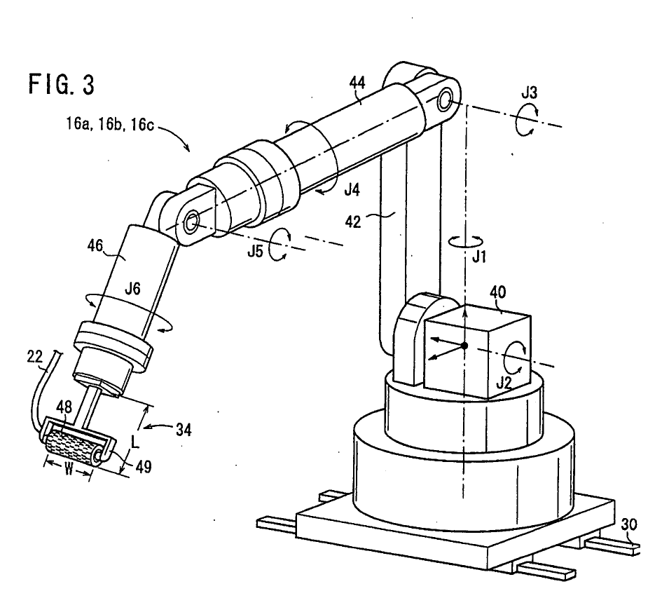

As shown in FIG. 3, robots 16a, 16b, 16c are, for instance, multi-jointed industrial robots, and have a base region 40, and in order based on said base region 40, a No. 1 arm 42, a No. 2 arm 44, and a No. 3 arm 46, while roller mechanism 34 is established on the tip end of said No. 3 arm 46. No. 1 arm 42 can rotate about axes/axles J1, J2 extending parallel and perpendicular to base region 40. No. 2 arm 44 is connected in a manner which can rotate relative to No. 1 arm 42 about axis/axle J3. No. 2 arm 44 can also twist or rotate about axis/axle J4. No. 3 arm 46 is connected in a manner which can rotate relative to No. 2 arm 44 about axis/axle J5. No. 3 arm 46 can also twist or rotate about axis/axle J6.

The roller mechanisms 34 which are connected to the tip ends of the No. 3 arms 46 of the robots can be set to move to any position in close proximity to the vehicle 14 and set to any direction by the motion of these six axis/axle robots 16a, 16b, 16c. In other words, the roller mechanisms 34 can move with six degrees of freedom. The robots 16a, 16b, 16c may also have an action region which has a parallel link motion, telescopic motion or extension motion, or the like, besides the rotating motion.

The roller mechanism 34 is mounted on the tip end of No. 3 arm 46, and has a cylindrical shaped roller 48 with width W which can absorb and hold the protective layer forming material. The roller 48 is connected in a manner which can freely rotate to retention part 49, and the application material piping 22 is connected to one end of retention part 49. The protective layer forming material is provided to the center region of the roller 48 from the application material piping 22, and oozes out to the surface of the roller 48. The material of the roller 48 can be, for instance, sponge, artificial fur, or the like. Furthermore, the roller 48 is made to be able to attach and detached from retention part 49 so that replacement, washing or maintenance can be readily performed.

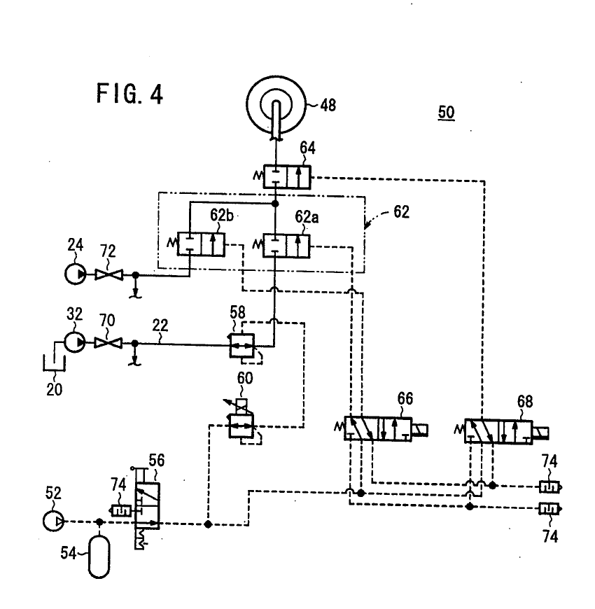

As shown in FIG. 4, the complex hydraulic and pneumatic circuits (supply mechanism) 50 for supplying the protective layer forming material to the roller 48 include compressor 52, air tank 54, which is connected to the out port of the compressor 52, pneumatic input valve 56 which manually switches between supplying and blocking pneumatic pressure, regulator 58 which reduces the downstream side pressure according to an electric signal provided from the controller 18, and regulator operating valve 60 which operates the pilot and reduces the pressure in the application material piping 22 by the downstream pressure of the regulator 58. Furthermore, the complex circuit 50 also has a material control valve (MCV) 62 which is connected to the water piping 26 and the downstream side piping of the regulator operating valve 60, and trigger valve 64 which is established between the downstream side of the MCV 62 and the roller 48. Switchover valves 62a, 62b, which connect and switchover the application material piping 22 and water piping 26, are established inside the MCV 62, and the downstream sides of the switchover valves 62a, 62b are connected. The dotted line in FIG. 4 shows the pneumatic piping.

The MCV 62, trigger valve 64, and regulator operating valve 60 are not restricted to pneumatic pilot type valves according to the invention, and it is acceptable if the drive systems are electric solenoids or the like.

The complex circuit 50 also has CMV switchover electromagnetic valve 66 which operates the switchover valves 62a, 62b by the pilot method by changing the pneumatic pressure supplied to the pneumatic input valve 56, and trigger switchover electromagnetic valve 68 which pilots the trigger valve 64. The MCV switchover electromagnetic valve 66 connects to either of the switchover valves 62a, 62b and blocks off the other side based on the electric signal supplied from the controller 18, and supplies either water or the protective layer forming material to the trigger valve 64. Trigger switchover electromagnetic valve 68 switches between connecting and blocking the trigger valve 64 in order to supply either water or the protective layer forming material to the roller 48 based on electric signals supplied from the controller 18.

Manual stop valves 70, 72 are established part way along the application material piping 22 and water piping 26. Normally, the stop valves 70 and 72 are left open. Silencers 74 are established at each of the air exit ports in the complex circuit 50 in order to reduce exit air noise. The compressor 52, pump 32, and water supply source 24 have relief valves (not shown in drawings) established to prevent excessive pressure rise.

The compressor 52, air tank 54, water supply source 24, and pump 32 in the complex circuit 50 are common for all robots 16a, 16b, 16c, but other devices are individually prepared for each of the robot 16a, 16b, 16c.

Next, a method will be described to apply the protective layer forming material to vehicle 14 using the application system 10 for the protective layer forming material with this type of construction.

First, motion training for the robots 16a, 16b, 16c is conducted beforehand or in advance. Responsibilities for bonnet region 14a (refer to FIG. 1), roof center region 14b, and roof back region 14c of the vehicle 14 are divided between the robots 16a, 16b, 16c respectively. The robots 16a, 16b, 16c are trained to apply the protective layer forming material to each region of responsibility, and this training data is recorded and saved in a designated memory of controller 18. In the case where the vehicle 14 is a sedan, the robot 16c will be responsible for the trunk region.

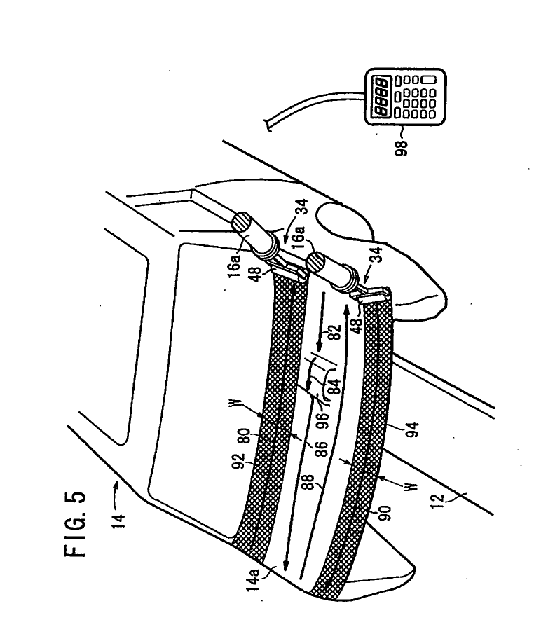

As shown in FIG. 5, with regards to the robot 16a, training is performed for stroke tracks 80, 82, 84, 86, 88, 90 so that the protective layer forming material is applied in widths W of the roller 48, and in particular, training is performed so that there is no excess application at edge regions shown by hatched regions 92, 94. The roller mechanism 34 is able to correspond to complex shapes because it is able to move in six degrees of freedom because of the structure of the robot 16a. For instance, even for the intake region 96, the protective layer forming material can positively be applied by moving along movement track 84. Furthermore, by appropriately adjusting the viscosity of the protective layer forming material, flowdown of the protective layer forming material can be prevented and the protective layer forming material can be applied even to sharply sloped edges such as hatched region 94. Additionally, by adjusting the viscosity to be high, even the perpendicular side surfaces of vehicle 14 can be appropriately coated. According to an important aspect of the present invention, the perpendicular painted regions can be protected during a vehicle assembly operation via application of the protective layer forming material such that the vehicle body will not be scratched and it will not be necessary to apply a conventional scratch cover to this region.

When training the motion of the robots 16a, 16b, 16c, the robots can be actually moved by the controller 18, robot controller 28a, or a special operating pendant 98. At this time, training is performed while the operator visually confirms that the roller 48 is in contact along the vehicle 14.

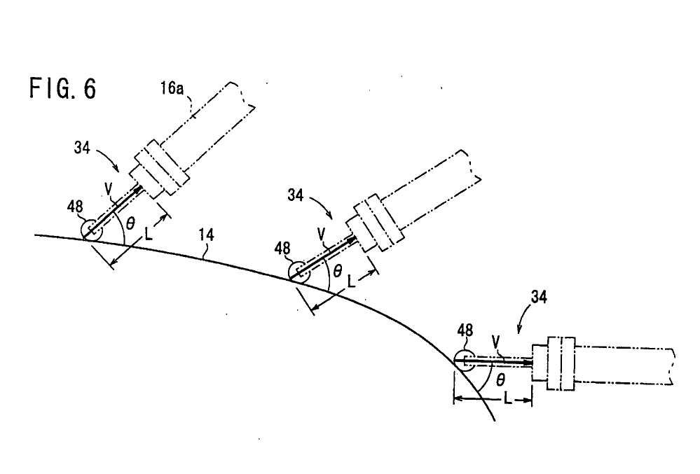

Furthermore, training can be performed, for instance, using three-dimensional CAD (computer-aided design) employing a solid model or the like without actually using the robot 16a, 16b, 16c, and motion training may also be performed using a so-called off-line training method. In this case, as shown in FIG. 6 for instance, vector V with length L is set at an appropriate angle θ to the vehicle surface based on configuration data for the vehicle 14, and the motions of the robots 16a, 16b, 16c may be automatically set so that the axle of the roller mechanism 34 matches this vector V.

The process of applying the protective layer forming material should be trained to be completed within the tact time established for each single vehicle 14 on the transport line 12.

Next, when the protective layer forming material is applied to the vehicle 14, the tank 20 (refer to FIG. 4) and application material piping 22 may be heated to an appropriate temperature by the designated heaters, while the compressor 52, water supply source 24, and pump 32 are activated. Furthermore, the robots 16a, 16b, 16c are positioned to wait such that interference with the vehicle 14 will not occur, and the pneumatic input valve 56 is opened.

Next, the vehicle 14 which has completed painting is introduced or brought by the transport line 12, and stops in close proximity to the robots 16a, 16b, 16c. The controller 18 determines that the vehicle 14 has been introduced by a signal supplied from the transport line 12 or a sensor (not shown in drawings), and the robots 16a, 16b, 16c are made to operate based on the training data.

At this time, the controller 18 controls the regulator operating valve 60 through the regulator 58 (refer to FIG. 4), and restricts the application material piping 22 to an appropriate pressure. Furthermore, the controller 18 controls the MCV 62 through the MCV switchover electromagnetic valve 66, and connects to the application material piping 22 while blocking the water piping 26. Furthermore, the controller 18 connects to the trigger valve 64 by operating the trigger switchover electromagnetic valve 68. The protective layer forming material is therefore maintained at an appropriate pressure and temperature by the action of this type of controller 18, and is supplied to the roller 48 of the roller mechanism 34 and oozes out at an appropriate rate onto the surface of the roller 48. In this manner, the protective layer forming material can be appropriately applied to the vehicle 14. Furthermore, the thickness of the protective layer forming material applied to the vehicle 14 can be adjusted by the pressure control of the regulator 58 and the motion speed of the robots 16a, 16b, 16c, as well as by adjusting the viscosity of the material.

At this time, the vehicle 14 should of course be finished with painting and may be an uncompleted vehicle without the various parts attached. In actuality, the object to which the protective layer forming material is applied is the body which makes up the vehicle 14, and the protective layer forming material may be applied before the finished vehicle stage. Because other components such as windows and doors or the like are not attached to the vehicle body at this stage, the application process is simple. Furthermore, by establishing the process of applying protective layer forming material immediately after the painting process for the vehicle body, the time that the painted surface is exposed to the environment can be shortened, and the painted surface can be protected from dust or the like even on transport line 12. Moreover, with regards to the doors for instance, protective layer forming material may be applied in a separate process where the doors are manufactured.

The vehicle 14 to which the protective layer forming material has been applied by the robots 16a, 16b, 16c, is transported to the next process by the transport line 12. The robots 16a, 16b, 16c wait in a queue that will not interfere with the vehicle 14 until the next vehicle 14 is introduced. At this time, the supply of the protective layer forming material may be stopped by blocking off using the trigger valve 64.

The applied protective layer forming material, which may be dried by natural drying or by forced air, forms a peelable protective layer and protects the painted region of the vehicle 14. By adjusting the ingredients of the protective layer forming material, the color of the peelable protective layer formed when the protective layer forming material dries can be made to be transparent, so that the color of the vehicle 14 can be confirmed therethrough. The color of the peelable protective layer may, however, be semi-transparent (including transparent with color) to the degree that the color of the vehicle can be confirmed.

Furthermore, this peelable protective layer is actually peeled off at a stage prior to use as a finished product, and specifically by a person at the dealer, who may use sprayed water for such purpose, prior to transfer to the user/customer. In this case, if a high pressure spray is applied in a lateral direction or from the bottom toward the edge of the peelable protective layer, the peelable protective layer can easily be peeled off the vehicle in sheet(s). This operation does not require great skill, and can be performed easily. In this case it is acceptable to use a car wash sprayer for the high pressure spray. Moreover, the peelable protective layer is consistently applied by the protective layer forming material application system 10 and there are no locations where the film thickness is thin, so that the layer can be easily peeled off without breaking in the middle during peeling. Note that the peelable protective layer will not peel off when low pressure water is applied from the top, so that it will not peel off naturally when contacted by rain.

The transport line 12 may accommodate multiple vehicle types and there may be differences in detailed configuration even between identical vehicle types. These detailed configurations may include, for instance, the presence or lack of a sunroof hole (refer to FIG. 1), an air intake 96 (refer to FIG. 5), expanded regions (also referred to as bulges), or a rear spoiler, or the like. In order to accommodate these multiple vehicle types and detailed configurations, the robots 16a, 16b, 16c should be trained according to each individual vehicle type and detailed configuration. The controller 18 receives a signal showing the vehicle types and detailed configuration from the transport line 12, and can select the training data based on this signal to drive the robots 16a, 16b, 16c.

Furthermore, when work is completed or during maintenance, the MCV 62 is made to function by the MCV switchover electromagnetic valve 66 so that the switchover valve 62a is closed and the switchover valve 62b is opened. By doing this, water is supplied from the water piping 26, and MCV 62, trigger valve 64, and roller 48 of the roller mechanism 34 can be washed. Because the roller 48 is made to be able to attach and detach relative to the retention part 49, it is also possible to remove the roller 48 from roller mechanism 34 and wash it independently.

As described above, with the application system 10 and application method for a protective layer forming material of the above described embodiment of the present invention, the roller mechanism 34 which has the roller 48 is operated by the robots 16a, 16b, 16c, while the protective layer forming material is supplied to the roller 48, and therefore the process of applying the protective layer forming material can be automated and the application quality can be made consistent. Therefore, there will be no regions with insufficient peelable protective layer film thickness, and the coating object or vehicle 14 painting quality can be maintained for a long time. Also, unnecessarily thick peelable protective layer film thicknesses can be prevented, and the operating cost of the plant can be reduced.

Furthermore, through automation, the number of processes can be reduced and production efficiency can be increased because the process where operators manually apply the protective layer forming material can be eliminated. In addition, air conditioning equipment for the comfort of operators can be eliminated. Therefore, energy can be conserved because the power required for air conditioning is reduced, the process can be made more environmentally friendly, and the operating costs in the plant can be reduced.

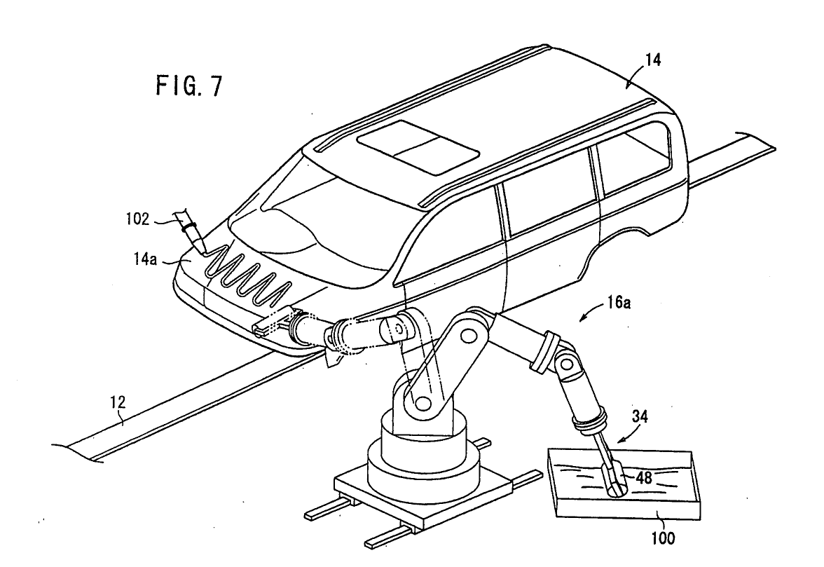

In the protective layer forming material application system 10, the case was described where the protective layer forming material is supplied to the application material piping 22 from the pump 32. However, for instance, as shown in FIG. 7, is also acceptable to establish a tray 100 (supply mechanism) which holds the protective layer forming material, and after immersing the roller 48 in the tray 100, the robots 16a, 16b, 16c are controlled to apply the protective layer forming material to the vehicle 14. In this manner, complex circuit 50 is unnecessary, and the structure can be simplified.

The peelable protective layer formed by the protective layer forming material can protect the painted regions of vehicle 14 before, during and after shipping, and can also function as a scratch cover to protect the painted regions within the plant. Therefore, the multiple scratch covers for different each configuration of vehicle can be eliminated.

Furthermore, it is also acceptable to first drip or spray protective layer forming material onto vehicle 14 using an appropriate nozzle or other appropriate drip mechanism 102 (refer to FIG. 7), and then spread the protective layer forming material out using the roller mechanism 34.

Still further, for regions of the vehicle 14 which have complex or detailed configurations that cannot be automatically handled by the robots 16a, 16b, 16c, it is also acceptable for operators to apply a finishing application. In this case, the regions where the protective layer forming material is manually applied will be reduced, so the burden on operators is still greatly minimized.

There are cases where the bumper of the vehicle 14 is colored and does not require painting, but the protective layer forming material can also be applied to regions other than painted regions such as this type of bumper, or the like. Furthermore, the object to which protective layer forming material is applied is not restricted to vehicles, and the object may also be road signs, billboards or the like. The equipment for applying the protective layer forming material is not restricted to robots 16a, 16b, 16c, and any motion trainable device is acceptable.

The system and method of applying a protective layer forming material according to the present invention is not restricted to the above described embodiments, and the use of various configurations is of course acceptable and contemplated as long as the fundamentals of the present invention are not deviated from. For example, it will be understood by persons skilled in the art that variations and modifications may be made to the described embodiments without departing from the spirit or essence of the invention.

As described above, with the system and method of applying a protective layer forming material of the present invention, it is possible to achieve the effects of automating the process of applying the protective layer forming material and improving production efficiency. Furthermore, the operation can be simplified and application quality can be made consistent.

Moreover, by using an acrylic type copolymer as the protective layer forming material, the vehicle can be better protected and the protective layer will easily peel off when it is removed.

What is claimed is:

1. A system for applying a protective layer forming material to a surface of an object, comprising:
a motion-trainable application equipment located near an object transport line;
a liquid protective layer forming material which forms a peelable protective layer when dry;
a roller mechanism with a freely rotating roller and operatively associated with said application equipment;
a supply mechanism which supplies said protective layer forming material to said roller; and
a controller which controls said application equipment;
said controller maintains training data for training said application equipment to cause said roller to contact a surface of the object and rotate; and
when said object is transported near said application equipment, said controller controls said application equipment to move based on said training data and said protective layer forming material is provided to said roller by said supply mechanism and at the same time said protective layer forming material is applied to an exterior surface of said object.

2. A system for applying a protective layer forming material as defined in claim 1, wherein said application equipment comprises a robot and said object is a vehicle.

3. A system for applying a protective layer forming material as defined in claim 1, wherein said protective layer coating material comprises an acrylic type copolymer.

4. A system for a applying protective layer forming material as defined in claim 1, wherein said supply mechanism includes a supply switchover valve which can selectively supply water and said protective layer forming material to said roller, and said controller supplies water to said roller to wash the roller by controlling said supply switchover valve.

5. A system for applying a protective layer forming material as defined in claim 1, wherein said controller maintains multiple blocks of said training corresponding to the type of object to be coated, and said controller moves said application equipment based on training data which corresponds to the type of object to be coated.

6. A system for applying a protective layer as defined in claim 1, wherein said roller includes a material which absorbs and holds said protective layer forming material.

7. An object having a protective layer coating material applied thereto by the protective layer application system as defined in claim 1.

8. An object having a peelable protective layer formed thereon, wherein the peelable protective layer is formed by applying a protective layer coating material to the object by the protective layer application system as defined in claim 1, and then drying the applied protective layer coating material.

9. An object having a peelable protective layer formed thereon as defined in claim 8, wherein said peelable protective layer is transparent.

10. A method for a applying protective layer forming material onto a surface of an object, involving use of a motion-trainable application equipment to apply a liquid protective layer forming material which forms a peelable protective layer after drying and a roller mechanism which is operatively associated with said application equipment and has a freely rotating roller, the method comprising the steps of:
training motions of said application equipment in advance based on a shape of an object;
supplying said protective layer forming material to said roller; and
when said object is brought near, controlling said application equipment to execute said trained motions, and said roller is made to contact a surface of said object and rotate while said protective layer forming material is applied.

11. A method for applying a protective layer forming material as defined in claim 10, wherein said application equipment comprises a robot and said object is a vehicle.

12. A method for applying a protective layer forming material as defined in claim 10, wherein said object is a component of a finished product, and said protective layer forming material is applied to said object at an intermediate stage of manufacturing the finished product.

13. A method for applying a protective layer forming material as defined in claim 12, wherein said protective layer forming material is applied to said object after said object has had a prescribed paint applied thereto.

14. A method for applying a protective layer forming material as defined in claim 10, wherein said peelable protective layer is peeled off said object prior to use as a finished product.

15. A method for applying a protective layer forming material as defined in claim 14, wherein said peelable protective layer is peeled off by spraying water at an edge of the peelable protective layer.

16. A method for applying a protective layer forming material as defined in claim 10, wherein said protective layer coating material comprises an acrylic type copolymer.

17. A method for a applying protective layer forming material as defined in claim 10, further involving use of a supply mechanism including a supply switchover valve which can selectively switched to supply either water or said protective layer forming material to said roller, and said method further including the step of controlling said supply mechanism to supply water to said roller to wash the roller.

18. A method for applying a protective layer forming material as defined in claim 10, including the further step of maintaining multiple blocks of said training corresponding to the type of object to be coated, and said controlling step involves moving said application equipment based on training data which corresponds to the type of object to be coated.

19. A method for applying a protective layer as defined in claim 10, wherein said roller includes a material which absorbs and holds said protective layer forming material.
